(19) United States
(12) Patent Application Publication
(10) Pub. No.: US 2016/0334524 A1
(43) Pub. Date: Nov. 17, 2016

(54) HEATED SEISMIC SENSOR TOOL AND METHOD

(71) Applicant: CGG SERVICES SA, Massy Cedex (FR)

(72) Inventors: Thomas PREUSSER, Calgary (CA); Jason JUROK, East Grinstead (GB)

(21) Appl. No.: 15/138,292

(22) Filed: Apr. 26, 2016

Related U.S. Application Data
(60) Provisional application No. 62/160,618, filed on May 13, 2015.

(51) Int. Cl. G01V 1/16; G01V 1/18; G01V 1/00

(52) U.S. Cl. CPC G01V 1/166; G01V 1/003; G01V 1/181

(57) ABSTRACT

A seismic acquisition system includes a seismic sensor tool for collecting seismic data and an external tool for coupling to the seismic sensor tool to provide energy. The seismic sensor tool includes a base plate and the external tool includes an inductive coil part. The base plate is energized by the inductive coil part through an inductive process to generate heat for melting ice or snow or frozen ground in contact with a housing of the seismic sensor tool.

### CROSS REFERENCE TO RELATED APPLICATIONS

The present application claims the benefit of priority under 35 U.S.C. §119(e) to U.S. Provisional Application No. 62/160,618 filed on May 13, 2015, the entire contents of which are hereby incorporated by reference.

### BACKGROUND

1. Technical Field

Embodiments of the subject matter disclosed herein generally relate to methods and systems for deploying/retrieving seismic sensor tools for collecting land seismic data and, more particularly, to mechanisms and techniques for improving a coupling to the ground of the seismic sensor tools in subfreezing conditions.

2. Discussion of the Background

Land seismic data acquisition and processing may be used to generate a profile (image) of the geophysical structure under the ground (subsurface). While this profile does not provide an accurate location for oil and gas reservoirs, it suggests, to those trained in the field, the presence or absence of such reservoirs. Thus, providing a high-resolution image of the subsurface is important, for example, to those who need to determine where oil and gas reservoirs are located.

Traditionally, a land seismic survey is performed in the following way. Plural geophones electrically connected to each other need to be deployed on the ground or below the ground. This process is very labor-intensive because thousands of geophones need to be deployed. Seismic personnel mark the desired locations of the geophones and manually dig a hole for each geophone. After the geophone is manually deployed into its corresponding hole, the seismic personnel manually cover the geophone with the dug dirt. Alternatively, the geophones are placed above the earth's surface, with no digging involved.

After all the geophones have been deployed, one or more seismic sources are brought into the field and actuated to generate the seismic waves. The seismic waves propagate through the ground until they are reflected by various reflectors. The reflected waves propagate to the geophones, where a movement of the earth is recorded. However, if the coupling between the geophone and the dirt around it is not good, the recorded data is poor.

The conventional geophones 100 are either placed on the ground 102 as shown in FIG. 1, or buried, manually or mechanically, in a small hole 204 in the ground and then covered with dirt 206 for a better coupling as shown in FIG. 2. A geophone typically has a cylindrical shape and a small size. Thus, a coupling between the geophone and the ground might be a problem. The coupling may be achieved by the weight of the geophone or by other means, e.g., a spike connected to the geophone and inserted into the ground. However, the coupling between the ground and geophone is not well understood. The geophone-ground coupling may be defined as the difference between the motion (e.g., velocity) measured by the geophone and the motion of the ground without the geophone. This definition is appropriate for designing a geophone.

However, once the geophone is designed and needs to be deployed, the practicing geophysicist has to deal with the fact that the geophone may not be appropriately deployed. For example, the geophone may not be coupled “well” to its surroundings. In this situation, the above definition might not be appropriate. For this situation, those skilled in the art would consider that a bad geophone coupling refers to the difference between the motion as measured by the badly planted geophone and the motion as measured by the well-planted geophone.

Irrespective of the definition to be used, the ground-geophone coupling is a persistent problem in the field. Weight coupling generally is not well-behaved because the contact area between the geophone (or another sensor) and the ground is rough. Often, the only way to improve the coupling is to increase the mass of the geophone so that the contact with the ground becomes better (stronger coupling resulting in more regular contact area). In practice, geophones are kept lightweight because of weight limits imposed on transporting thousands of geophones. Thus, the requirements for (1) light weight and (2) a good coupling by weight work against each other.

Therefore, there is a need to improve the coupling of the geophone to the ground without increasing the weight of the geophone to improve the quality of recorded data.

### SUMMARY OF THE INVENTION

According to an exemplary embodiment, there is a seismic acquisition system that includes a seismic sensor tool for collecting seismic data and an external tool for coupling to the seismic sensor tool to provide energy. The seismic sensor tool includes a base plate and the external tool includes an inductive coil part. The base plate is energized by the inductive coil part through an inductive process to generate heat for melting ice or snow or frozen ground in contact with a housing of the seismic sensor tool.

According to another exemplary embodiment, there is a seismic sensor tool for collecting seismic data. The seismic sensor tool includes a housing having a sealed chamber, an inductive coil part located within the housing, and a base plate which is energized by the inductive coil part through an inductive process to generate heat for melting ice or snow or frozen ground around the housing.

According to still another embodiment, there is a method for improving a contact between a seismic sensor tool and the ground. The method includes a step of placing the seismic sensor tool on or in the ground, a step of inductively energizing a base plate of the seismic sensor tool with an external tool to generate heat in the base plate, a step of melting ice or snow or a frozen ground around a housing of the seismic sensor tool, a step of improving a contact between the housing and the ice or snow or frozen ground by refreezing, and a step of recording seismic data with a seismic sensor located inside the housing.

### BRIEF DESCRIPTION OF THE DRAWINGS

For a more complete understanding of the present invention, reference is now made to the following descriptions taken in conjunction with the accompanying drawings, in which:

FIG. 1 illustrates a geophone deployed above ground;

FIG. 2 illustrates a geophone deployed below ground;

FIG. 3 illustrates a seismic sensor tool having a base plate that is heated with an external tool for a better coupling with the ground;

FIGS. 4A-C illustrate various details of the base plate;

FIG. 5A shows a partially buried seismic sensor tool and FIG. 5B shows a fully buried seismic sensor tool, both equipped with a base plate;

FIGS. 6A and 6B illustrate an attachment mechanism that attaches the base plate to a housing of the seismic sensor tool;

FIG. 7 illustrates an embodiment in which the base plate is received by a pocket of the housing;

FIG. 8 illustrates an embodiment in which the base plate is formed within the housing of the seismic sensor tool;

FIG. 9A illustrates an embodiment in which an induction coil part is within the housing of the seismic sensor tool and the base plate is outside the housing;

FIG. 9B illustrates an embodiment in which both the induction coil part and the base plate are inside the housing;

FIG. 10 is a flowchart of a method for heating a base plate of a seismic sensor tool; and

FIG. 11 is a schematic diagram of a computing device capable of implementing one or more of the methods discussed in the embodiments.

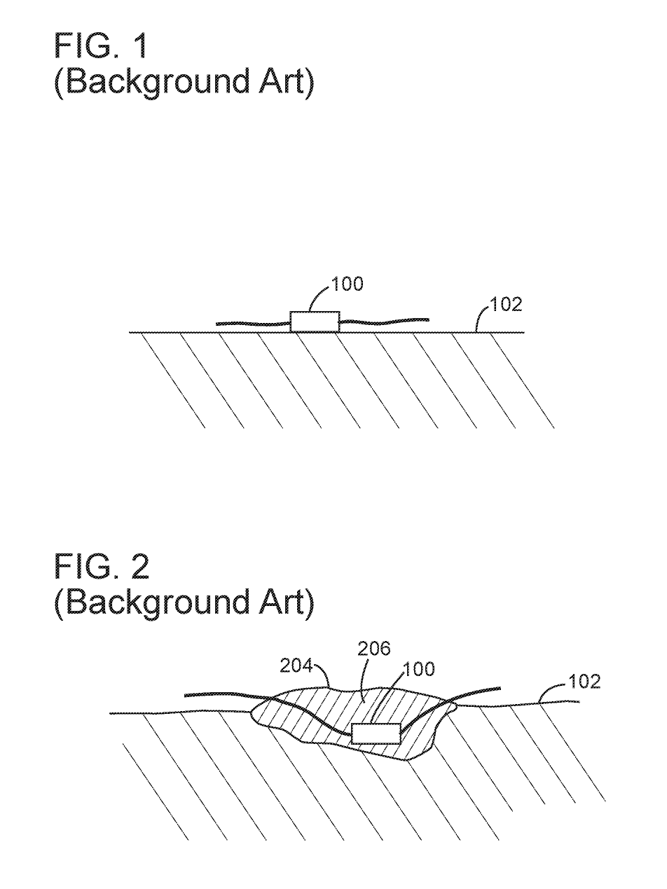

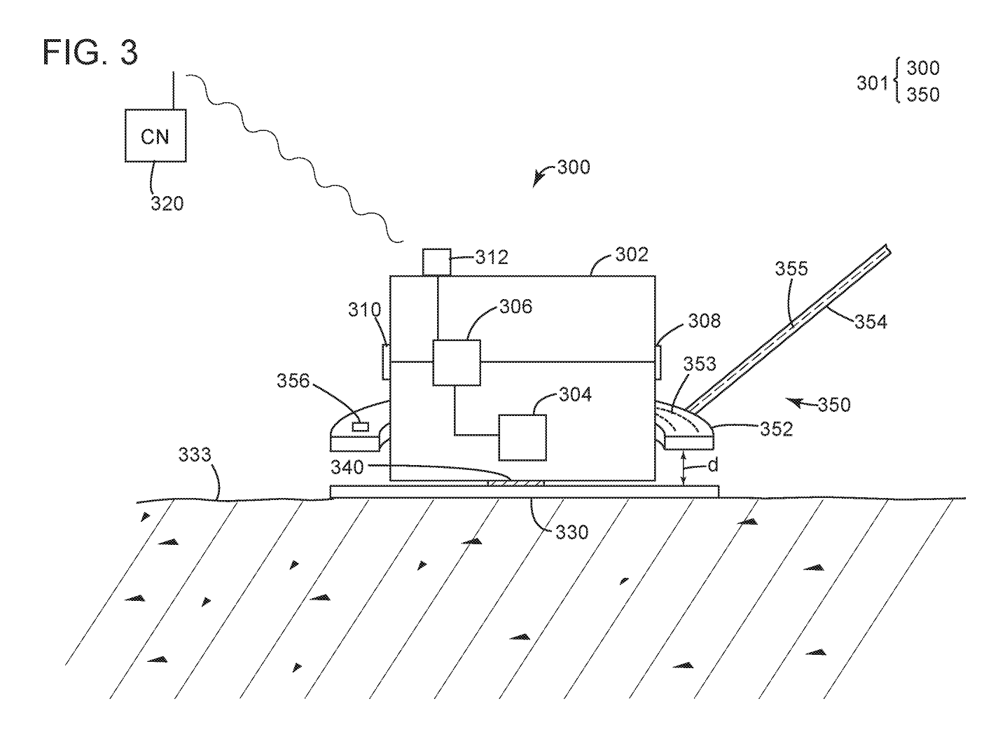

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a land seismic system that includes seismic sensors. However, the embodiments to be discussed next are not limited to seismic sensors, they may be applied to other type of sensors or non-sensor devices (e.g., a survey marker, etc.).

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a seismic sensor tool includes a housing, a seismic sensor and a heating mechanism. The heating mechanism may receive its power from a power source located inside or outside the housing. The heating mechanism is used to heat ice/snow/frozen ground surrounding the seismic sensor tool. After refreezing, the frozen water located between the housing and the ground offers an improved coupling of the seismic sensor to the ground. The same heating mechanism may be used to melt the frozen water so that the housing can be retrieved from the ground, when the seismic survey is over.

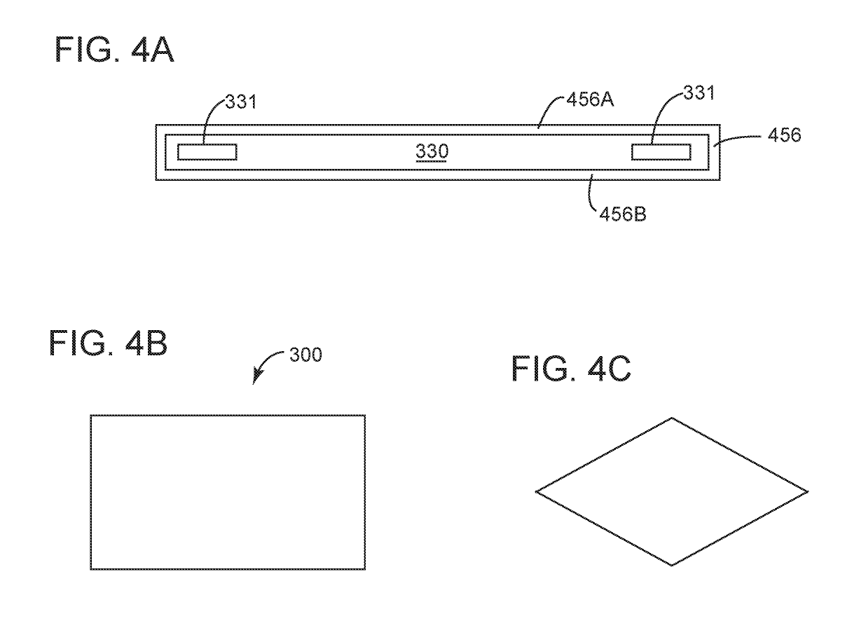

According to an embodiment illustrated in FIG. 3, a seismic sensor device 300 has a housing 302 that accommodates at least a seismic sensor 304. The seismic sensor may be not only the geophone discussed above, but a hydrophone, accelerometer, optical sensor or a combination of them. In one application, the seismic sensor is completely located inside the housing. Some seismic sensor devices may also include electronics (e.g., digitizer, memory, power source) 306 that is connected to seismic sensor 304 and also to external ports 308 and 310. The external ports are configured to be physically connected to cables that extend to other seismic sensor tools if the seismic sensor tool is wired. If the seismic sensor tool is wireless, then ports 308 and 310 are replaced by a transceiver module 312, located inside or outside housing 302. Transceiver module 312 is configured to wirelessly communicate with neighboring seismic sensor tools or a central station 320. The same transceiver module may be used to communicate with a local data collector (not shown), which may be carried by a person or by a vehicle, for collecting the seismic data. Transceiver module is configured to receive instructions from the central station and to transmit seismic data and/or other data back to the central station, if necessary.

According to this embodiment, the housing is attached to a base plate 330, which may be a plate having any shape. Base plate 330 may be made of a ferromagnetic material. In one embodiment, the base plate may be a laminated structure with highly permeable steel plates and surrounded, partially or totally, by a highly conductive and anti-oxidant outer layer, such as aluminum. Base plate 330 may be removably attached to the exterior of the housing 302 with an attachment mechanism 340. This means, that base plate 330 may be snapped in and out of the attachment mechanism as necessary. In one embodiment, the base plate is screwed to the attachment mechanism or directly into the housing. Other means for attaching the base plate to the attachment mechanism or to the housing may be imagined. In one embodiment, the attachment mechanism is fixedly attached to the base plate but it is removably attached to the housing.

The base plate is attached to the housing for the purpose of better coupling the sensor to the ground. For those seismic surveys that take place in freezing conditions, if the base plate is heated when the seismic sensor tool is deployed, the refreezing of the water would fix the base plate and implicitly the housing of the seismic sensor tool to the ground, thus achieving an excellent coupling with the ground.

The base plate may be heated in various ways. For example, an external tool 350 may be placed over the housing 302, as shown in FIG. 3, to heat by induction the base plate 330. External tool 350 may have an induction coil part 352 that mates with part of the base plate. The induction coil part has a hole that fits over the bulk of the housing 302 as illustrated in FIG. 3. However, the induction coil part can have no hole. The induction coil part 352 may be positioned over base plate 330 so that a distance “d” between these two elements has a desired value, e.g., zero to a few millimeters. An arm 354 is attached to the induction coil part and this arm may be handled by a person or by a machine to automatically heat base plate 330. Induction coil part 352 may include one or more coils 353, which when supplied with AC current through wires 355 located in arm 354, create eddy currents in the base plate 330. Because the base plate is made of a ferromagnetic material, the eddy currents heat up the base plate through its electrical resistance. Wires 355 are connected to a source of AC power, which is carried either by a person, for example, in a back pack, or by the machine that deploys the seismic sensor tools. In this embodiment, seismic sensor tool 300 and external tool 350 are part of a seismic acquisition system 301.

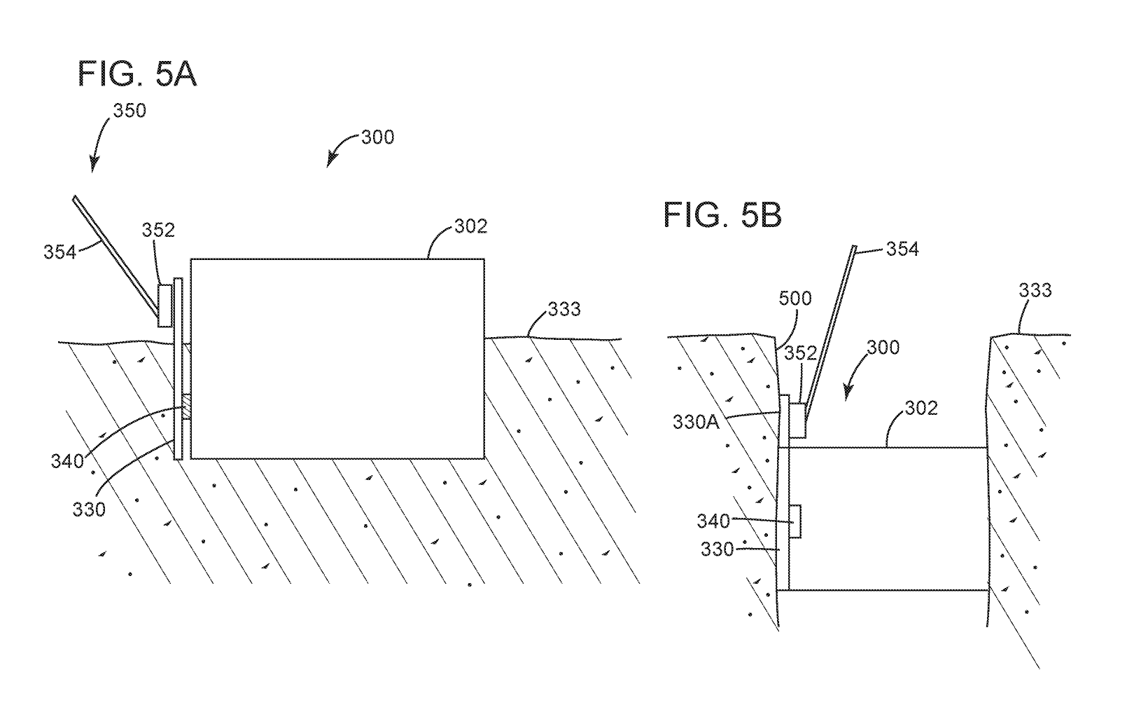

The base plate 330 may be coated with an insulating material 456, as illustrated in FIG. 4A. The purpose of the insulating material 456 may be two-fold, first to prevent the base plate from corrosion, and second to prevent forming a direct electrical circuit between the induction coil part and the base plate. In one embodiment, only the upper part 456A of the insulating material may be present with the bottom of the base plate free of any insulating material. In another embodiment, it is possible that only a bottom part 456B of the insulating material is present while the upper part is missing. In still another embodiment, it is possible that the entire insulating material 456 is missing and the induction coil part is covered with an insulating material. FIGS. 4B-C illustrate rectangular and rhombic shapes for the base plate. Other shapes are also possible. Base plate 330 may have one or more magnetic portions 331 for providing magnetic attraction to the induction coil part 352, so that the seismic sensor tool is properly engaged and aligned during deployment. In other words, when the external tool 350 is located over the base plate 330, due to the magnetic attraction between the external tool and the base plate, the seismic sensor tool is fixedly attached to the external tool so that the operator or machine handling the external tool can easily control the orientation of the seismic sensor tool. The same effect can be achieved by providing the magnet or an electromagnet (element 356 in FIG. 3) on the external tool, e.g., the induction coil part, and not on the base plate. The electromagnet may be activated only during placement of the seismic sensor tool.

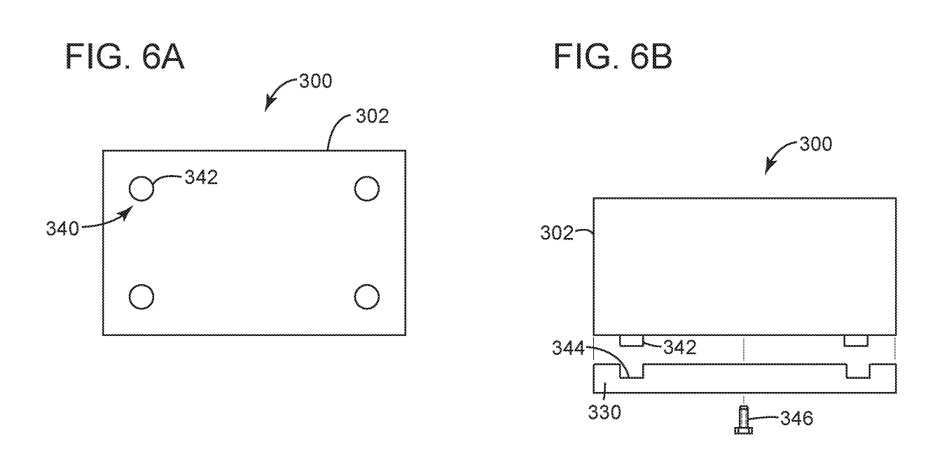

Returning to FIG. 3, one will note that the seismic sensor tool 300 is placed above the earth's surface 333. However, it is possible to place the seismic sensor tool partially or totally under the earth's surface, as illustrated in FIGS. 5A and 5B. FIG. 5A shows the seismic sensor tool 300 partially placed below the earth's surface 333. In this case, the base plate 330 may be placed on a side of the housing 302, partially extending above and partially extending below the earth's surface 333. In this way, the part extending above the earth's surface may contact the induction coil part 352 to form the Eddy's currents and consequently heat the base plate. The base plate may be formed only on one side of the housing, two or more sides, all sides, the bottom side or a combination of these sides. If the housing is circular, the base plate may be curved to cover a part of the housing.

FIG. 5B shows a well 500 that was dug to accommodate the seismic sensor tool 300. In this case, the base plate 330 may be formed only on a side of the housing or the entire lateral side for contacting the walls of the well. The seismic sensor tool is shown in this figure being located completely below the earth's surface. The base plate 330 may extend past housing 302, so that a portion 330A can be contacted by the induction coil part 352 as shown in FIG. 5B. Other arrangements may be used for achieving the induction between the base plate and the external tool.

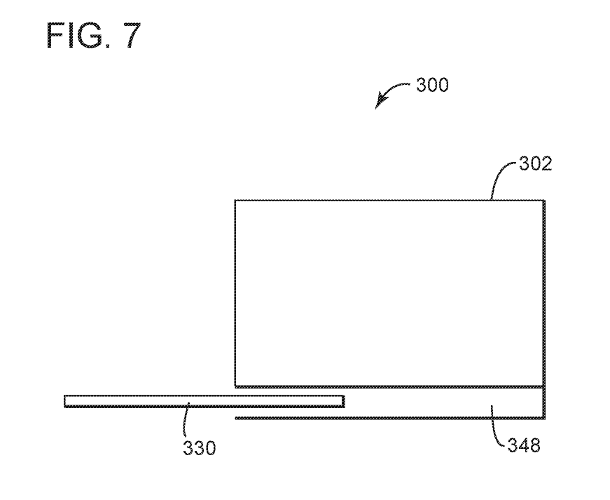

Attachment mechanism 340 may be implement in different ways. For example, as illustrated in FIGS. 6A-B, attachment mechanism 340 may include one or more male parts 342 that fit inside corresponding female parts 344, located on the base plate 330. In one application, the male parts are located on the base plate and the female parts on the housing 302. Alternatively, one or more screws 346 may be inserted through the base plate, into the housing, to attach the base plate to the housing. While these figures shows the base plate being attached to the bottom of the housing, as discussed previously, the base plate may be attached on one or more sides of the housing, or only to partially cover the bottom side.

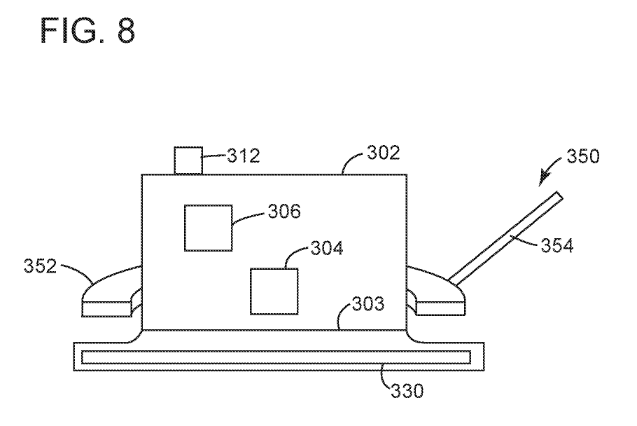

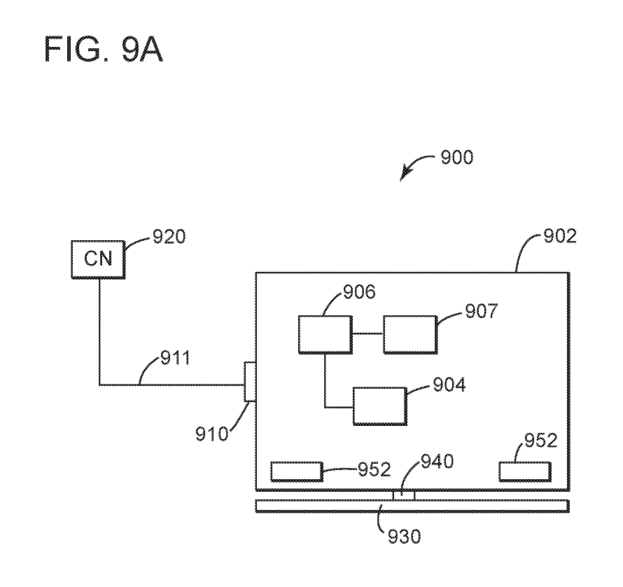

In an embodiment illustrated in FIG. 7, housing 302 has a pocket 348 formed on the bottom side (or any other side), in which the base plate 330 can simply be inserted or removed as necessary. The base plate may have different shapes, as required by the specific seismic survey. Pocket 348 may be formed from a material that has a good thermal conductivity, so that the heat induced in the base plate can be easily transmitted to the ambient for melting the snow/ice/frozen ground. Base plate 330 may be longer than the pocket so that a part of the base plate sticks out of pocket. In this way, the external tool 350 may still be used to induce the eddy currents into the base plate. In still another embodiment illustrated in FIG. 8, the base plate 330 is formed completely inside the housing 302. An internal wall 303 may be formed between the base plate and the seismic sensor 304 for sealing the seismic sensor. The housing may be shaped as shown in the figure so that external tool 350 still can approach the base plate and induce eddy currents.

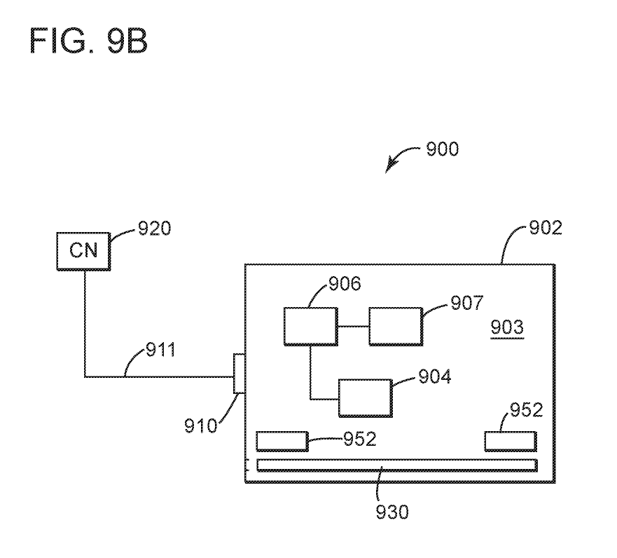

In still another embodiment, it is possible to have the induction coil part 952 formed to be part of housing 902, as shown in FIG. 9A. In this embodiment, induction coil part 952 is formed inside housing 902 and base plate 930 is removably attached to the housing 902 with attachment mechanism 940. In still another embodiment, both the induction coil part 952 and the base plate 930 are located inside the housing 902 of the seismic sensor tool 900, as illustrated in FIG. 9B. In this embodiment, housing 902 has a sealed chamber 903 that accommodates the sensor 904, various electronics 906, a power source 907, if present, the induction coil part 952 and optionally, the base plate 930. Note that base plate 930 may also be located outside chamber 902. For both configurations, the housing may also include a power source 907 for generating the AC current in the coil. Power source 907 may include one or more batteries, a fuel cell, etc. Alternatively, if the seismic sensor tool is connected through a cable 911 to the central station 920, electric power may be transmitted from the central station to the induction coil while seismic data may be transmitted from the seismic sensor 904 to the central station 920.

All the above embodiments have been discussed as using an inductive heating method for heating the base plate. However, those skilled in the art would understand that other mechanisms may be used, for example, resistive heating. For a resistive heating seismic sensor tool, there would be a need for an electrical interface between the housing and the tool. This interface is not necessary for the inductive heating discussed above, which is advantageous when the medium in which the sensor tools are deployed is wet and/or muddy as the electrical current can leak and harm the operator. Thus, while it is advantageous to use the inductive heating discussed above, each of the above embodiment may also be modified to have an electrical interface to receive electrical current from the external tool 350.

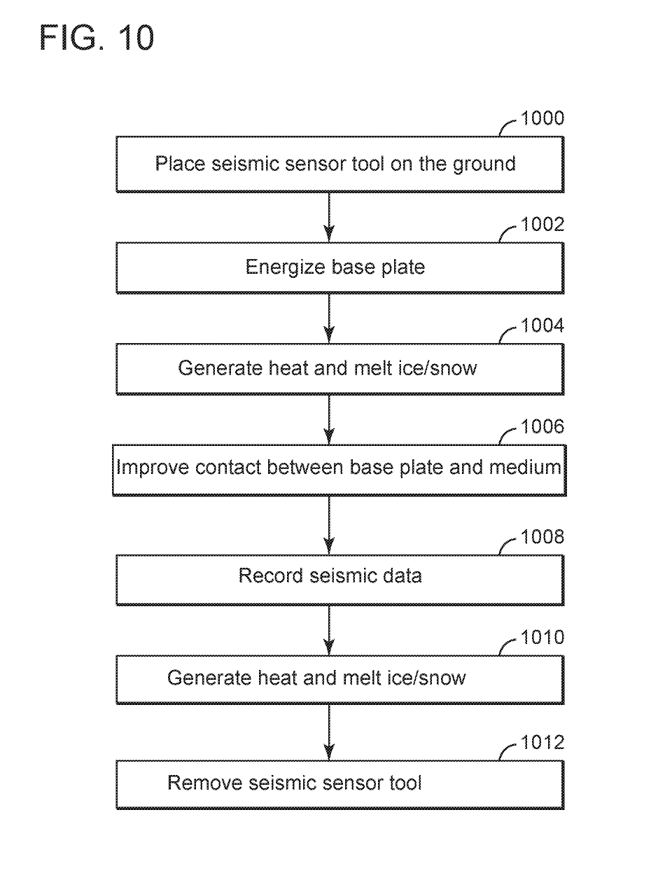

A method for deploying and/or retrieving such seismic sensor tool is now discussed with regard to FIG. 10. While the embodiments discussed above are more appropriate for a seismic survey that experiences freezing temperatures, they can be applied for any kind of environment. However, this method is considered for a seismic survey in which snow, ice or a frozen ground is present.

In step 1000, seismic sensor tool 300 is attached to external tool 350. External tool 350 may be handled by a person or by a machine. Note that, as illustrated in FIG. 3, external tool 350 may be placed over part of the housing 302, i.e., external tool 350 slides over the top of the housing 302. In another embodiment, the external tool 350 may be placed on a side of the housing 302 as later shown in FIGS. 5A and 5B. If an electromagnet is present in the external tool, the electromagnet is activated to hold the seismic sensor tool attached to the external tool. If no electromagnet or magnet is present, the seismic sensor tool is simply placed on the ground (or buried, partially or totally into the ground).

Next, in step 1002, a current is sent from the external tool 350 to the inductive coil part 350, to energize the base plate 330. This step may last between seconds to tens of seconds, depending on the ambient temperature and the capability of the power source. For example, if the vehicle deploys the seismic sensor tool, the amount of power used to generate the heat is not of concern. If a person uses a back pack type external tool to deploy the seismic sensor tools, the time for heating the ground is shortened (e.g., under one minute) to preserve power. If the power source of the seismic sensor tool is used to heat the base plate, that time can be even shorter. In one application, the time the base plate is energized depends on the ground condition, e.g., if the ground/ice/snow is considerably frozen, more heat is applied to the base plate, if the ground/ice/snow is slightly frozen, less heat is applied to the base plate. Thus, in one application, the amount of time the inductive coil part is turned on varies with the ambient temperature. As a consequence of this step, heat is generated in step 1004 and the ice/snow/frozen ground surrounding and/or contacting the housing 302 is partially melted.

The melted ice/snow/frozen ground refreezes in step 1006, which creates a better contact between the base plate (and implicitly the housing) and the medium. In step 1008, seismic data is sensed or recorded with the seismic sensors until a decision is made to retrieve the seismic sensor tools. For the retrieving phase, as the housing of the seismic sensor tool is frozen in place, it is possible in step 1010 to place again the external tool over the housing, or to send a command to the power source of the seismic sensor tool, to induce heat into the base plate to melt the ice/snow/frozen ground so that a contact between the housing and the ambient is weakened. After this is achieved, the seismic sensor tool is either manually or mechanically removed in step 1012 from the ground or stored on the vehicle or somewhere else.

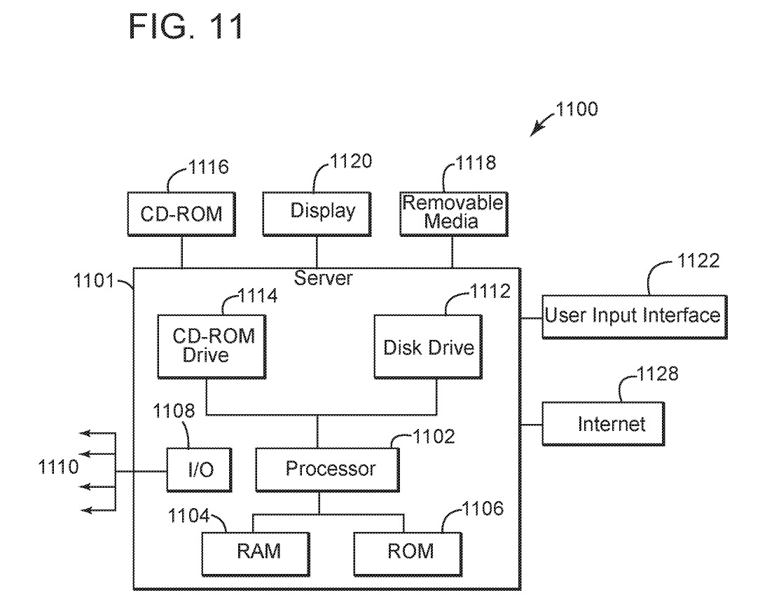

The above method and others may be implemented in a computing system specifically configured to drive the vehicle. An example of a representative computing system capable of carrying out operations in accordance with the exemplary embodiments is illustrated in FIG. 11. Hardware, firmware, software or a combination thereof may be used to perform the various steps and operations described herein.

The exemplary computing system 1100 suitable for performing the activities described in the exemplary embodiments may include server 1101. Such a server 1101 may include a central processor (CPU) 1102 coupled to a random access memory (RAM) 1104 and to a read-only memory (ROM) 1106. The ROM 1106 may also be other types of storage media to store programs, such as programmable ROM (PROM), erasable PROM (EPROM), etc. The processor 1102 may communicate with other internal and external components through input/output (I/O) circuitry 1108 and bussing 1110, to provide control signals and the like. The processor 1102 carries out a variety of functions as are known in the art, as dictated by software and/or firmware instructions.

Server 1101 may also include one or more data storage devices, including a hard drive 1112, CD-ROM drives 1114, and other hardware capable of reading and/or storing information such as DVD, etc. In one embodiment, software for carrying out the above-discussed steps may be stored and distributed on a CD-ROM 1116, removable memory device 1118 or other form of media capable of portably storing information. These storage media may be inserted into, and read by, devices such as the CD-ROM drive 1114, the disk drive 1112, etc. The server 1101 may be coupled to a display 1120, which may be any type of known display or presentation screen, such as LCD, LED displays, plasma display, cathode ray tubes (CRT), etc. A user input interface 1122 is provided, including one or more user interface mechanisms such as a mouse, keyboard, microphone, touch pad, touch screen, voice-recognition system, etc.

Server 1101 may be coupled to other computing devices, such as the landline and/or wireless terminals via a network. The server may be part of a larger network configuration as in a global area network (GAN) such as the Internet 1128, which allows ultimate connection to the various landline and/or mobile client devices. The computing device may be implemented on a vehicle that performs a land seismic survey.

The disclosed exemplary embodiments provide a system and a method for improving a coupling between a seismic sensor tool and the ground. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A seismic acquisition system comprising:
a seismic sensor tool for collecting seismic data;
an external tool for coupling to the seismic sensor tool to provide energy;
the seismic sensor tool includes a base plate; and
the external tool includes an inductive coil part,
wherein the base plate is energized by the inductive coil part through an inductive process to generate heat for melting ice or snow or frozen ground in contact with a housing of the seismic sensor tool.

2. The system of claim 1, wherein the seismic sensor tool comprises:
a seismic sensor located within the housing and configured to sense the seismic data.

3. The system of claim 1, further comprising:
an attachment mechanism through which the base plate is removably attached to the housing of the seismic sensor tool.

4. The system of claim 1, wherein the base plate is attached to a bottom part of the housing.

5. The system of claim 1, wherein the base plate is located inside a pocket of the housing.

6. The system of claim 1, wherein the base plate is located inside the housing.

7. The system of claim 1, wherein the base plate is located outside the housing.

8. The system of claim 1, wherein the base plate is located on a side of the housing.

9. The system of claim 1, wherein the external tool comprises:
the induction coil part; and
an arm connected to the induction coil part,
wherein the arm supplies alternative current to the induction coil part for inducing eddy currents into the base plate.

10. The system of claim 9, wherein the induction coil part includes an electromagnet for attracting the base plate.

11. The system of claim 1, wherein the base plate is covered with an insulating material which separates the base plate from the induction coil part.

12. The system of claim 1, wherein the base plate includes a magnetic material for attracting the external tool.

13. A seismic sensor tool for collecting seismic data, the seismic sensor tool comprising:
a housing having a sealed chamber;
an inductive coil part located within the housing; and
a base plate which is energized by the inductive coil part through an inductive process to generate heat for melting ice or snow or frozen ground around the housing.

14. The tool of claim 13, wherein the base plate and the inductive coil part are located inside the sealed chamber.

15. The tool of claim 13, wherein the inductive coil part is located inside the sealed chamber and the base plate is located outside the housing.

16. The tool of claim 13, wherein the inductive coil part is energized by a power source located inside the sealed chamber.

17. The tool of claim 13, wherein the inductive coil part is energized by a power source located outside the housing.

18. A method for improving a contact between a seismic sensor tool and the ground, the method comprising:
placing the seismic sensor tool on or in the ground;
inductively energizing a base plate of the seismic sensor tool with an external tool to generate heat in the base plate;
melting ice or snow or a frozen ground around a housing of the seismic sensor tool;
improving a contact between the housing and the ice or snow or frozen ground by refreezing; and
recording seismic data with a seismic sensor located inside the housing.

19. The method of claim 18, further comprising:
placing the external tool along the housing to bring an inductive coil part of the external tool next to the base plate.

20. The method of claim 18, further comprising:
inductively energizing again the base plate of the seismic sensor tool with the external tool to generate heat in the base plate; and
removing the seismic sensor tool from ground.
